(19) United States
(12) Patent Application Publication
(10) Pub. No.: US 2009/0276520 A1
(43) Pub. Date: Nov. 5, 2009

(54) METHOD AND APPARATUS FOR SERVER ELECTION, DISCOVERY AND SELECTION IN MOBILE AD HOC NETWORKS

(75) Inventors: Ishan P. WEERAKOON, Rockville, MD (US); Mei Ngan, Germantown, MD (US); Suresh K. Iyer, Germantown, MD (US); Prakash M. Sesha, Boyds, MD (US); Jeanette M. Kee, Rockville, MD (US); Garth McGINLEY, Gaithersburg, MD (US)

Correspondence Address: PRASS LLP, 2661 Riva Road, Bldg. 1000, Suite 1044, ANNAPOLIS, MD, 21401, US

(73) Assignee: LOCKHEED MARTIN CORPORATION, Bethesda, MD (US)

(21) Appl. No.: 12/258,391

(22) Filed: Oct. 25, 2008

Related U.S. Application Data
(60) Provisional application No. 61/050,381, filed on May 5, 2008.

(51) Int. Cl. G06F 15/173

(52) U.S. Cl. 709/224; 709/223

(57) ABSTRACT

A method and apparatus for server election, discovery and selection in mobile ad hoc communication networks is disclosed. The server election method may include a server node that may elect itself as a server in network if the received server capabilities, network server lists and network specific parameters allow its election as a server in the network. A client node may discover and select a server in the network by transmitting a server discovery request to a plurality of nodes in the network, receiving advertisements from one or more servers in the network in response to the server discovery request, and selecting a server based on the received stability and connectivity information for each server from which advertisements are received.

### PRIORITY INFORMATION

This application claims priority from U.S. Provisional Patent Application Ser. No. 61/050,381, filed May 5, 2008, the contents of which are incorporated herein by reference.

### BACKGROUND OF THE DISCLOSURE

1. Field of the Disclosure

The disclosure relates to mobile ad hoc communication networks.

2. Introduction

Various network services such as domain name service and directory services employ a classic client server architecture in which each client selects a server either by static configuration or by dynamic selection at startup, and attempts to maintain the relationship with that server until at least a complete failure to obtain network services exists. However, in dynamic networks with mobility, network dynamics can change rapidly and therefore the efficiency and economy of the initially chosen server relationship for one or more clients can change substantially during a session. In deployment topologies such as military (tactical) networks, there may be multiple nodes that are able to provide the server capability for one or more network services. However, particularly in military networks and other networks with similar characteristics, conventional technologies lack the ability to dynamically and continually select the most efficient server for a given client as the network dynamics change due to reasons including mobility and server availability.

### SUMMARY OF THE DISCLOSED EMBODIMENTS

A method and apparatus for server election, discovery and selection in mobile ad hoc communication networks is disclosed. The server election method may include a server node that may elect itself as a server in network if the received server capabilities, network server lists and network specific parameters allow its election as a server in the network. A client node may discover and select a server in the network by transmitting a server discovery request to a plurality of nodes in the network, receiving advertisements from one or more servers in the network in response to the server discovery request, and selecting a server based on the received stability and connectivity information for each server from which advertisements are received.

### BRIEF DESCRIPTION OF THE DRAWINGS

In order to describe the manner in which the above-recited and other advantages and features of the disclosure can be obtained, a more particular description of the disclosure briefly described above will be rendered by reference to specific embodiments thereof which are illustrated in the appended drawings. Understanding that these drawings depict only typical embodiments of the disclosure and are not therefore to be considered to be limiting of its scope, the disclosure will be described and explained with additional specificity and detail through the use of the accompanying drawings in which:

FIG. 1 illustrates an exemplary diagram of a mobile ad-hoc communications network in accordance with a possible embodiment of the disclosure;

FIG. 2 illustrates a block diagram of an exemplary server node in accordance with a possible embodiment of the disclosure;

FIG. 3 illustrates is an exemplary flowchart illustrating one possible server election process in accordance with one possible embodiment of the disclosure;

FIG. 4 illustrates a block diagram of an exemplary client node in accordance with a possible embodiment of the disclosure; and

FIG. 5 illustrates is an exemplary flowchart illustrating one possible server discovery and selection process in accordance with one possible embodiment of the disclosure.

### DETAILED DESCRIPTION OF THE DISCLOSURE

Additional features and advantages of the disclosure will be set forth in the description which follows, and in part will be obvious from the description, or may be learned by practice of the disclosure. The features and advantages of the disclosure may be realized and obtained by means of the instruments and combinations particularly pointed out in the appended claims. These and other features of the present disclosure will become more fully apparent from the following description and appended claims, or may be learned by the practice of the disclosure as set forth herein.

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The disclosure comprises a variety of embodiments, such as a method and apparatus and other embodiments that relate to the basic concepts of the disclosure. This disclosure concerns a method and apparatus for server discovery and selection in mobile ad hoc communication networks. In particular, the disclosure may concern a dynamic server election and selection process within a general framework of network services including networks with the characteristics of tactical network topologies. The disclosed server election process may define a method of selecting a set of nodes that can provide a particular network service for a given network. The disclosed server selection process may define a method to be employed by each client node to dynamically select a server for a network service. Each client may continuously monitor the efficiency of its server choice as the network dynamics change, and may select a new server when the efficiency of the existing server relationship dips below a predetermined threshold. The apparatus of the disclosure may concern at least a memory, a communication interface, and a processor (or modules) that perform the server election, discovery, selection and re-selection processes discussed herein and in the attached materials.

Networks such as military tactical networks (and other similar networks), although including mobile nodes, typically involve a substantial degree of planning and provisioning before deployment. These networks may include many nodes that are capable of performing as a server (server capable nodes) for one or more network services. The process discussed in this disclosure takes advantage of such network characteristics, such as multiple nodes capable of providing network services and particular network topologies and mobility patterns, in order to establish and maintain an optimal server relationship for each client. The process may elect (server election) an optimal set of server nodes from between the nodes capable of providing such services, and then, on a client by client basis, may allow each client to select and continually reselect a server that is most efficient for its own circumstances. The process may recognize and account for the tradeoff between the desire to have multiple servers for a network service and the cost of maintaining multiple servers, such as maintaining server data synchronization, for example.

In the process of the disclosure, an optimal set of nodes may be selected from the network nodes to provide a particular network service. (e.g., Domain Name Service (DNS)). The clients may discover these server nodes and select a server node based on one of route triggers or application triggers. The client may reselect the server if the parameters change due to a change in network dynamics, for example.

With regard to the process for electing a set of servers, server capable nodes may be configured with a set of parameters (e.g., server capability, types of services, expected mobility, node priority number, etc.). The server capable nodes may also be configured with network specific parameters, including the desired/maximum number of servers allowed in the network. At start-up and/or network entry, each server capable node may broadcast or multicast its server capability parameters and may initially treat itself as a server for the network. Each node, including server capable nodes, may periodically broadcast or multicast the current network server list as seen by that node. Within a bounded time duration, each server capable node may be expected to receive communications from the majority of other server capable node. A server capable node may elect itself a server for the network depending on factors such as if the number of desired servers for network is not reached, the content of the broadcast announcements(e.g., server capability parameters, network server list as seen by each node), and a node priority order, for example.

With respect to the process for selecting a server, periodic server advertisements may be issued and/or a client may send server discovery requests. All servers may respond to the client (which may be multicast or broadcast) if the requested service profile is matched. The server response may contain a mobility pattern and/or connectivity information. The client may receive the information and select the server based on stability and/or connectivity, for example.

With respect to the method for maintaining optimal connectivity to server, the performance of the link to the server may be monitored. This process may concern measuring the response time to service messages, regular ping messages, etc., for example. When the performance dips below a predetermined threshold, the server selection may be re-initiated.

A further description of the above processes is provided below:

Server Election
The network may elect a maximum of a pre-specified number of servers. When a node is initialized and connected to the network, by default that node may consider itself a server.
The node may then computes a “desirability index” based on its stability (see metric defined below in server reselection), connectivity (defined as the number of one hop neighbors), and capacity.
Each node may broadcast its current server list along with its own desirability index each time the list is updated (could also be at some defined interval). The list may be prioritized in order of the desirability index.
Each node may transmit this list only so long as it finds itself within the maximum number of servers desired for the network.

Server Discovery
Client nodes, upon startup or entering a new network, may broadcast or multicast (to a predefined group) a server discovery request.
The server discovery request may contain the identifier of the client, its current IP address, and the type of server being requested.
A server that minimally matches the type of server requested by the client may respond, unicasting the response to the client.

Server Selection
Clients may broadcast or multicast (to an appropriately defined multicast group) a server discovery request. In response, one or more servers may respond with server advertisements.
The server advertisement may include metrics specifying that server's stability, connectivity to other nodes, and remaining processing capacity.
   The metric of stability may be designed to measure a server's relative mobility.
   The metric of connectivity may be designed to measure the strength or robustness of the server's connectivity to the network.
Having received responses from multiple servers, the client may make a simple choice, such as choosing the server that responds first or a more complex choice involving the consideration of the various metrics reported.

Server Re-Selection
The responsiveness of the network services client-server communication model to network dynamics may be primarily dependent on the server reselection mechanism employed by clients.
Reselection mechanisms may be based on:
   Route triggers
   Application layer policy triggers
Route Trigger Process
   The client may initiate the reselection process either upon losing reachability to the currently selected server or upon a significant increase in route cost (i.e., hop count) to the selected server.
Application Trigger Process
   The client may initiate the reselection process upon an evaluation of a combination of metrics including round trip time, stability of the server, and connectivity of the server, for example.
      The stability may be defined based on how many neighbors of a server remain the same over a time period.

$${Stability}_{x} = \frac{N 1 ⋂ N 2}{N 1 ⋃ N 2}$$

where the stability of node x is based on its set of neighbors N (taken to be one hop neighbors) at two consecutive points in time. This may be referred to as the stability metric or stability threshold.

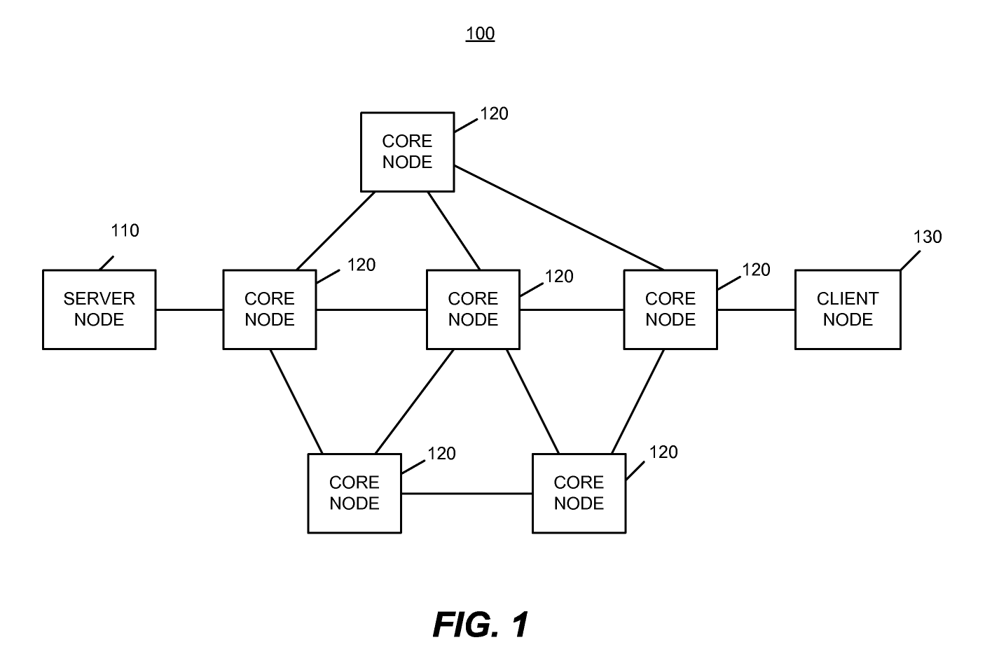

FIG. 1 illustrates an exemplary diagram of a communications network environment 100 in accordance with a possible embodiment of the disclosure. The communications network environment 100 may include a server node 110, plurality of core nodes 120, and a client node 130.

The mobile ad hoc communications network 100 may represent any possible communications network, for example, an Internet Protocol (IP) based network that may handle voice, data or video communications including computer networks, wireless telephone networks, other wireless device networks. etc., for example.

The server node 110, and client node 130 may represent any communication network device capable of voice, data, or video communications, including a computer, a server, a portable computer, a wireless radio, a wireless telephone, a portable digital video recorder, a cellular telephone, a mobile telephone, a personal digital assistant (PDA), a portable music player, or combinations of the above, for example. Although only a small number of nodes are shown in FIG. 1, this is merely illustrative. There may be any number of server nodes 110, and client nodes 130 in the mobile ad hoc communications network 100.

Nodes, such as the server and client nodes 110 and 130 may be co-located. A network may communicate packets of information among the nodes. For example, a server node 110, as well as other nodes, can produce packets which are destined for other nodes, such as client node 130. The packets of information which are transmitted over the network may carry data, Voice over Internet Protocol (VoIP), streaming audio, video telephone conference data, video information, such as Moving Picture Experts Group (MPEG) video, and other information.

When a packet of data is produced by the server node 110, it can carry an address tag identifying the destination node, such as client node 130. A packet leaving the server node 110 can traverse a path routed by one or more other nodes 120. Each successive node may move the packet toward the client node 130. Each movement of a packet from one node 120 to the next node 120 may be termed a “hop”.

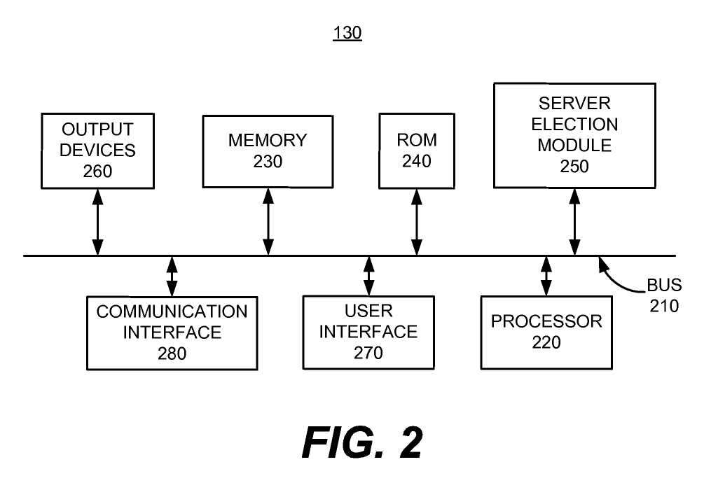

FIG. 2 illustrates a block diagram of an exemplary server node in accordance with a possible embodiment of the disclosure. The server node 110 may include a bus 210, a processor 220, a memory 230, ROM 240, a server election module 250, output devices 260, a user interface 270, and a communication interface 280. Bus 310 may permit communication among the components of the server node 110.

Processor 220 may include at least one conventional processor or microprocessor that interprets and executes instructions. Memory 230 may be a random access memory (RAM) or another type of dynamic storage device that stores information and instructions for execution by processor 220. Memory 230 may also store temporary variables or other intermediate information used during execution of instructions by processor 220. Memory 230 may also include any type of media, such as, for example, magnetic or optical recording media and its corresponding drive. ROM 240 may include a conventional ROM device or another type of static storage device that stores static information and instructions for processor 220.

User interface 270 may include one or more conventional input mechanisms that permit a user to input information, communicate with the server node 110, and/or present information to the user, such as a an electronic display, microphone, touchpad, keypad, keyboard, mouse, pen, stylus, voice recognition device, buttons, one or more speakers, etc. Output devices 260 may include one or more conventional mechanisms that output information to the user, including a printer, one or more speakers, or a medium, such as a memory, or a magnetic or optical disk and a corresponding disk drive.

Communication interface 280 may include any transceiver-like mechanism that enables the server node 110 to communicate via a network. For example, communication interface 280 may include a wireless network interface, an optical network interface, or an Ethernet interface. Alternatively, communication interface 280 may include other mechanisms for communicating with other devices and/or systems via wired, wireless or optical connections.

The server node 110 may perform such functions in response to processor 220 by executing sequences of instructions contained in a computer-readable medium, such as, for example, memory 230, a magnetic disk, or an optical disk. Such instructions may be read into memory 230 from another computer-readable medium, or from a separate device via communication interface 280.

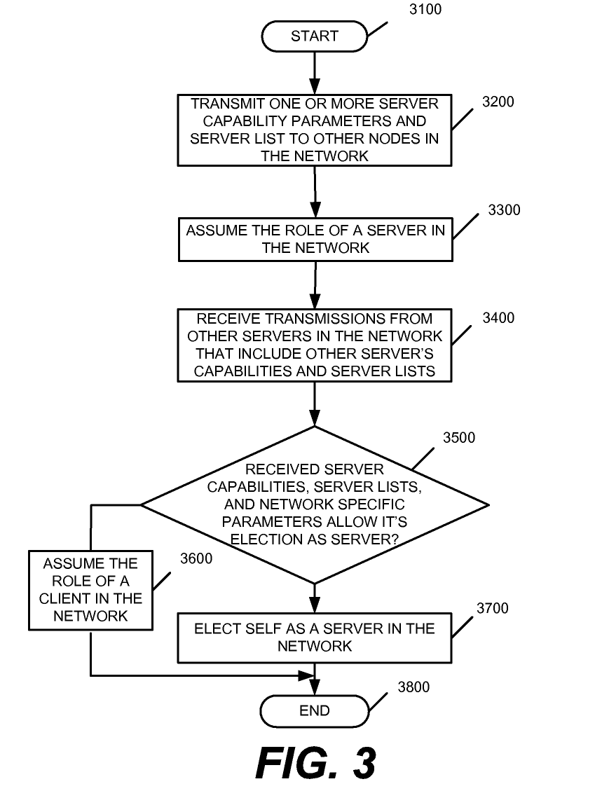

The operations and functions of the server election module 250 and server election process will be discussed in relation to the flowchart in FIG. 3.in relation to the diagrams shown in FIGS. 1 and 2, above.

FIG. 3 is an exemplary flowchart illustrating one possible server discovery and selection process in accordance with one possible embodiment of the disclosure. The process begins at step 3100 and continues to step 3200 where the server election module 250 may transmit one or more server capability parameters and a network server list to other nodes in the network 100 through the communication interface 280. The server capabilities may include its server capacity, types of services provided, expected mobility, or node priority number, for example. For instance, a server may list the various network services such as DNS that it supports, a server may report a maximum load and the level of current processing load. A node priority number may be provided to each server-capable node upon startup. The priority number may be based on various considerations such as the reliability of the node, the processing capability of the node, and the level of projected mobility of the node. The network server list may list the servers in the network 100 and their node priority numbers as recognized by each individual server 110 in the network 100.

At step 3300, the server election module 250 may enable the server node to assume the role of a server in the network 100. At step 3400, the server election module 250 may receive transmissions from other servers in the network 100 that include other server's capabilities and network server lists through the communication interface 280.

At step 3500, the server election module 250 may determine if the received server capabilities, network server lists and network specific parameters allow the server node's election as a server in the network 100. The network specific parameters may include the preferred number of servers in the network and the maximum number of servers in the network, for example. If the server election module 250 determines that the received server capabilities, network server lists, and network specific parameters allow its election as server in the network 100, at step 3700, the server election module 250 may enable the server node 110 to be elected as a server in the network 100. The process may then go to step 3800 and end.

If at step 3500, the server election module 250 determines that the received server capabilities, network server lists, and network specific parameters do not allow the server node's election as a server in the network 100, at step 3600, the server election module 250 may enable the server node 110 to assume the role of a client in the network 100. The process may then go to step 3800 and end.

The server election module 250 may set a timer to a predetermined time limit to receive responses from other servers. The timer may be incremented or decremented in any manner known to one of skill in the art. If the server election module determines that the timer has expired, then the server election module may determine if the one or more of received server capabilities, network server lists and network specific parameters allow its election as a server in the network.

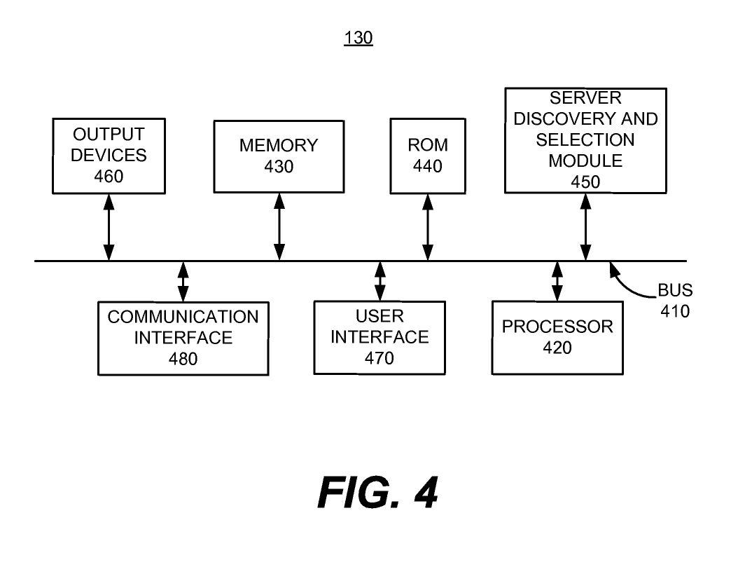

FIG. 4 illustrates a block diagram of an exemplary client node 130 in accordance with a possible embodiment of the disclosure. The client node 130 may include a bus 410, a processor 420, a memory 430, ROM 440, a server discovery and selection module 450, output devices 460, a user interface 470, and a communication interface 480. The bus 410, processor 420, memory 430, ROM 440, output devices 460, user interface 470, and communication interface 480 of the client node 130 may be similar in structure, function and operation as the bus 210, processor 220, memory 230, ROM 240, server election module 250, output devices 260, user interface 270, and communication interface 280 of the server node 110. Therefore, in the interest of brevity, their description need not be repeated here.

The server node 110 illustrated in FIGS. 1 and 2 the client node 130 illustrated in FIGS. 1 and 4 and the related discussion are intended to provide a brief, general description of a suitable computing environment in which the disclosure may be implemented. Although not required, the disclosed embodiments will be described, at least in part, in the general context of computer-executable instructions, such as program modules, being executed by the server node 110 and the client node 130, such as a general purpose computer. Generally, program modules include routine programs, objects, components, data structures, etc. that perform particular tasks or implement particular abstract data types. Moreover, those skilled in the art will appreciate that other embodiments of the disclosure may be practiced in network computing environments with many types of computer system configurations, including personal computers, hand-held devices, multi-processor systems, microprocessor-based or programmable consumer electronics, and the like.

Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

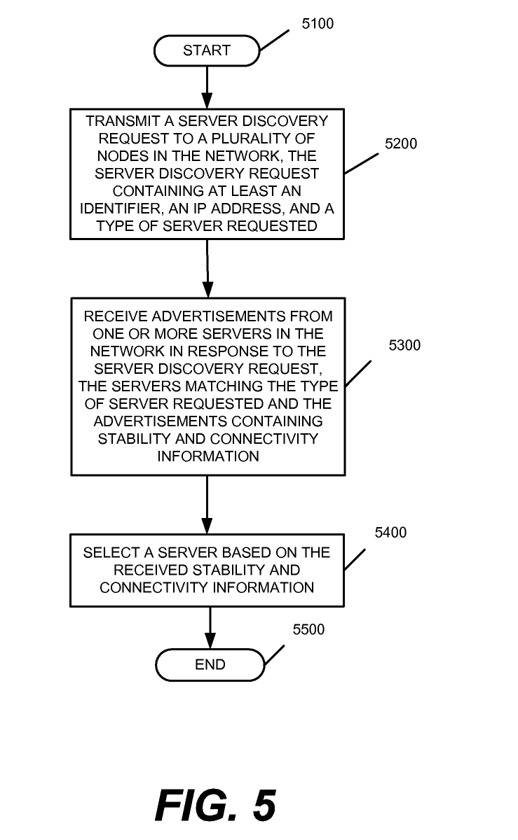

The operations and functions of the server discovery and selection module 450 and server election process will be discussed in relation to the flowchart in FIG. 5.in relation to the diagrams shown in FIGS. 1 and 4, above.

FIG. 5 is an exemplary flowchart illustrating one possible server discovery and selection process in accordance with one possible embodiment of the disclosure. The process begins at step 5100 and continues to step 5200 where the server discovery and selection module 450 may transmit a server discovery request to a plurality of nodes in the network 100 through the communication interface 280. The server discovery request may contain an identifier, an Internet Protocol (IP) address, and a type of server requested, for example.

At step 5300, the server discovery and selection module 450 may receive advertisements from one or more servers 110 in the network 100 in response to the server discovery request through the communication interface280. The one or more servers 110 may match the type of server requested and the advertisements may contain at least stability and connectivity information, for example. The stability information may include a measurement of a server's relative mobility in the network. The relative mobility may include the level of mobility of the server relative to its neighbors within a predetermined number of hops. As such, relative mobility may be a measure of how fast a node is moving within its network. A very stable node means that its relative mobility is low (infrequent change in neighbors), and a very unstable node means that its relative mobility is high (frequent change in neighbors).

The connectivity information may include at least one of strength of a server's connectivity, robustness of a server's connectivity, and load capacity information. The connectivity of a server, in one aspect, may be a measure of how reliable the server is expected to be. For example, having a higher number of one hop neighbors, in general, increases the strength or level of connectivity of that server because the server can be reached by routing packets through any one of the one hop neighbors.

At step 5400, the server discovery and selection module 450 may select a server based on the received stability and connectivity information for each server 110 from which advertisements are received. For example, the server reporting the highest weighted average of stability and connectivity may be selected. Some embodiments may consider additional factors such as, for example, reported server capabilities, reported server load, and the mobility of the client node. The process may then go to step 5500 and end.

After server selection, the server discovery and selection module 450 may monitor the performance of the selected server 110 and determine if the selected server's performance exceeds a predetermined threshold. If the server discovery and selection module 450 determines that the selected server's performance does not exceed a predetermined threshold, the server discovery and selection module may reselect another server 110 in the network 100.

Reselection may be based on route triggers or application layer policy triggers. With regard to route triggers, the server's performance may be one of reachability to the selected server and route cost (number of hops) between the selected server 110 and the client node 130. For example, a route trigger may be activated to select a new server if the route cost (e.g., hop count) exceeds a predetermined threshold at any time. With regard to application layer policy triggers, the server's performance may be an evaluation of one or more metrics that may include at least one of packet round trip time, stability of the server 110, and connectivity of the server 110. For example, a client node may monitor a packet round trip time to the server at intervals and activate the reselection process if the round trip time exceeds a predetermined threshold. Connectivity refers to the number of one hop neighbors that the server has. Performance may be monitored, for example, by determining if a server has a minimum level of connectivity in each time interval.

The stability of the server 110 may be defined based on how many neighbors of a server remains the same over a time period.

$${Stability}_{x} = \frac{N 1 ⋂ N 2}{N 1 ⋃ N 2}$$

where the stability of node x is based on its set of neighbors N (taken to be one hop neighbors) at two consecutive points in time. This may be referred to as the stability metric. Performance may be monitored by, for example, comparing the stability metric of a server at each time interval against a predetermined threshold.

Embodiments within the scope of the present disclosure may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments of the disclosure are part of the scope of this disclosure. For example, the principles of the disclosure may be applied to each individual user where each user may individually deploy such a system. This enables each user to utilize the benefits of the disclosure even if any one of the large number of possible applications do not need the functionality described herein. In other words, there may be multiple instances of the components in the disclosed embodiments each processing the content in various possible ways. It does not necessarily need to be one system used by all end users. Accordingly, the appended claims and their legal equivalents should only define the disclosure, rather than any specific examples given.

We claim:

1. A method for server election of a server node in a mobile ad hoc communication network having specific network parameters, comprising:
transmitting one or more server capability parameters and a network server list to other nodes in the network;
enabling the server node to assume the role of a server in the network;
receiving transmissions from other servers in the network that include other server's capabilities and network server lists;
determining if one or more of the received server capabilities, network server lists and network specific parameters allow the server node's election as a server in the network, wherein if it is determined that one or more of the received server capabilities, network server lists, and network specific parameters allow the server node's election as server,
enabling the server node to be elected as a server in the network.

2. The method of claim 1, wherein the server capabilities are at least one of its server capability, types of services provided, expected mobility, and node priority number.

3. The method of claim 1, wherein the network specific parameters include at least one of the preferred number of servers in the network and the maximum number of servers in the network.

4. The method of claim 1, wherein the network server list lists the servers in the network and their node priority numbers as recognized by each individual server in the network.

5. The method of claim 1, wherein if it is determined that the received server capabilities, network server lists, and network specific parameters do not allow the server node's election as server, enabling the server node to assume the role of a client in the network.

6. The method of claim 1, further comprising:
setting a timer to a predetermined time limit;
determining if the timer has expired, wherein if it is determined that the timer has expired,
determining if one or more of the received server capabilities, network server lists and network specific parameters allow the server node's election as a server in the network.

7. A server node in a mobile ad hoc communication network having specific network parameters, comprising:
a communication interface; and
a server election module that transmits one or more server capability parameters and a network server list to other nodes in the network through the communication interface, enabling the server node to assume the role of a server in the network, receives transmissions from other servers in the network that include other server's capabilities and network server lists through the communication interface, determines if one or more of the received server capabilities, network server lists and network specific parameters allow its election as a server in the network, wherein if the server election module determines that one or more of the received server capabilities, network server lists, and network specific parameters allow the server node's election as a server in the network, the server election module enables the server node to be elected as a server in the network.

8. The server node of claim 7, wherein the server capabilities are at least one of its server capability, types of services provided, expected mobility, and node priority number.

9. The server node of claim 7, wherein the network specific parameters include at least one of the preferred number of server in the network and the maximum number of server in the network.

10. The server node of claim 7, wherein the network server list lists the servers in the network and their node priority numbers as recognized by each individual server in the network.

11. The server node of claim 7, wherein if the server election module determines that the received server capabilities, network server lists, and network specific parameters do not allow the server node's election as a server in the network, the server election module enables the server node to assume the role of a client in the network.

12. The server node of claim 7, wherein the server election module sets a timer to a predetermined time limit and determines if the timer has expired, wherein if the server election module determines that the timer has expired, the server election module determines if one or more of the received server capabilities, network server lists and network specific parameters allow its election as a server in the network.

13. A method for server discovery and selection in a client node in a mobile ad hoc communication network, comprising:
transmitting a server discovery request to a plurality of nodes in the network, the server discovery request containing at least node identification information, an Internet Protocol (IP) address, and a type of server requested;
receiving advertisements from one or more servers in the network in response to the server discovery request, the one or more servers matching the type of server requested and the advertisements containing at least stability and connectivity information; and
selecting a server based on at least one of the received stability and connectivity information for each server from which advertisements are received.

14. The method of claim 13, wherein the stability information includes a measurement of a server's relative mobility in the network.

15. The method of claim 13, wherein the connectivity information includes at least one of strength of a server's connectivity, robustness of a server's connectivity, and load capacity information.

16. The method of claim 13, further comprising:
monitoring performance of the selected server; and
determining if the selected server's performance exceeds a predetermined threshold, wherein if it is determined that the selected server's performance does not exceed a predetermined threshold, reselecting another server in the network.

17. The method of claim 16, wherein the server's performance is one of reachability to the selected server and route cost between the selected server and the client node.

18. The method of claim 16, wherein the server's performance is an evaluation of one or more metrics that includes at least one of packet round trip time, stability of the server, and connectivity of the server.

19. A client node in a mobile ad hoc communication network, comprising:
a communication interface that facilitates communications with other nodes in the network; and
a server discovery and selection module that transmits a server discovery request to a plurality of nodes in the network through the communication interface, the server discovery request containing at least an identifier, an Internet Protocol (IP) address, and a type of server requested, receives advertisements from one or more servers in the network in response to the server discovery request through the communication interface, the one or more servers matching the type of server requested and the advertisements containing at least stability and connectivity information, and selects a server based on at least one of the received stability and connectivity information for each server from which advertisements are received.

20. The client node of claim 19, wherein the stability information includes a measurement of a server's relative mobility in the network.

21. The client node of claim 19, wherein the connectivity information includes at least one of strength of a server's connectivity, robustness of a server's connectivity, and load capacity information.

22. The client node of claim 19, wherein the server discovery and selection module monitors performance of the selected server, and determines if the selected server's performance exceeds a predetermined threshold, wherein if the server discovery and selection module determines that the selected server's performance does not exceed a predetermined threshold, the server discovery and selection module reselects another server in the network.

23. The client node of claim 22, wherein the server's performance is one of reachability to the selected server and route cost between the selected server and the client node.

24. The client node of claim 22, wherein the server's performance is an evaluation of one or more metrics that includes at least one of packet round trip time, stability of the server, and connectivity of the server.
